(19) United States
(12) Patent Application Publication
(10) Pub. No.: US 2008/0017357 A1
(43) Pub. Date: Jan. 24, 2008

(54) Cooling Device

(76) Inventor: Guiseppe Zeolla, Minusio (CH)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/594,558

(22) PCT Filed: Mar. 4, 2005
(86) PCT No.: PCT/EP05/02280

§ 371 Date: Sep. 27, 2006

(30) Foreign Application Priority Data
Mar. 28, 2004 (DE) 10 2004 015 505.4

(51) Int. Cl. B01D 35/00

(52) U.S. Cl. 165/119; 165/132; 210/435

(57) ABSTRACT

A cooling device comprises a cooling unit (10) through which a fluid to be cooled, in particular hydraulic oil, can flow, the unit having a housing (18) and at least one filter unit (12) for filtering the fluid. The housing (18) of the cooling unit (10) comprises at least one overhanging support arm (14) which establishes a fluid communication between the corresponding filter unit (12) and the cooling unit (10). The filter unit (12) with the filter clement is thus arranged outside the actual housing of the cooling unit (10), while being connected in an integrated manner to the same by means of the support arm (14).

The invention relates to a cooling device comprising a cooling unit through which a fluid to be cooled, in particular hydraulic oil, can flow, the unit having a device housing and at least one filter unit for filtration of the fluid.

These cooling devices can be used for a plurality of applications and are available in the most varied embodiments. The cooling device systems which have been freely available on the market to date however all consist either of a filter unit which is flanged to the cooling unit, or of tank units which are connected to the cooling units, the respective tank unit then holding the filter element. The known cooling devices are therefore generally composed of several components, and the actual cooling unit can be connected by way of the corresponding piping to the actual filter unit as the cooling device is being produced. Here it cannot be precluded that misconnections can occur in the indicated piping and consequently malfunction sources occur in the installation of the known cooling devices. Furthermore, the known cooling device solutions are structurally large due to the diversity of their parts and accordingly heavy; this is especially disadvantageous for mobile use.

Accordingly, in the known cooling device according to WO 01/65123 A1 it has already been suggested that the cooling unit and the filter unit be combined with each other in one piece, the filter unit together with the cooling unit being located in a device housing, so that a multipiece construction is avoided, and the known cooling device can be made much more compact and light with the same performance. By integrating the cooling unit and filter unit in one device housing moreover the conventional piping can be eliminated and hence malfunction sources are precluded. The disadvantage in this known solution is however that in the replacement process of a used filter element by a new one the device housing of the cooling unit must be opened; this is accompanied by a corresponding expenditure of time, and when the used filter element is removed from the device housing of the cooling unit, fluid components also end up on the outside; this can lead to contamination with the corresponding post-cleaning process.

CH 533 246 discloses a device for storing, filtering, and cooling of a fluid medium, especially for a hydraulic system, with a fluid container, in a vertical through opening surrounded by the jacket-shaped container above the fan there being a deflection housing which holds a filter through which flow takes place from top to bottom, which forms an annular cooling channel with the container and through which a stream of the filtered fluid flows from bottom to top. Furthermore, the connecting lines emerging from its top end are connected to the container such that the fluid flow which is now directed down remains in the action region of the cooling channel. These connecting lines together with a connection for the oil return from the hydraulic system form arms with which the deflection housing can be supported and mounted on the top of the container.

On the basis of this prior art, therefore the object of this invention is to further improve the known cooling devices while retaining their advantages such that they are compact and light-weight in design, that complex piping between the cooling unit and filter unit is eliminated, and that contamination in the replacement of the respective filter element can be prevented. This object is achieved by a cooling device with the features specified in claim 1 in its entirety.

In that, as specified in the characterizing part of claim 1, the device housing of the cooling unit has at least one overhanging support arm, via which the respective filter unit is connected to the cooling unit to carry fluid, the filter unit with the filter element is located outside of the actual device housing of the cooling unit, and still integrally connected by way of the support arm to the latter. With the support arm solution as claimed in the invention, it is possible to separate the filter unit with the respective filter element from the cooling unit without in the process having to open the device housing of the cooling unit, and since the cooling unit remains on site for example on a hydraulic machine, the filter unit can be moved with the respective filter element for a replacement process to a suitable location, where the contamination which arises in the process of replacing the filter element is of no concern. The unused and newly inserted filter element is then moved back onto the support arm by way of the filter unit, and the cooling device together with the filtering process can be started up again.

Since the support arm can be a one-piece component of the cooling unit with its device housing, complex piping together with the pertinent sealing systems is omitted and the fluid paths in particular can be kept short; this is favorable for the entire cooling device in terms of energy balance. Although the filter housing itself is no longer directly an integral component of the device housing of the cooling unit, but is located externally by way of the support arm, the total structural weight is reduced and in addition to a compact construction, the cooling device as claimed in the invention is also economical to produce and, as already indicated, economical to maintain, since complex after-cleaning due to overflowing hydraulic medium on the cooling device at any rate is not necessary.

In one preferred embodiment of the cooling device as claimed in the invention, the filter unit is located in the flow direction of the fluid, downstream from the cooling unit, so that the filter element is thermally protected. By preference the cooling unit is made as a plate-shaped finned radiator so that especially this plate configuration is advantageous when the installation spaces are kept flat. By preference the device housing is composed of sheet metal parts, and due to this modular design the production costs can be cut. But it is also possible to make the finned radiator as a casting, especially as an aluminum diecasting.

By using suitable bypass valves, the cooling device can be adapted to the most varied volumetric flows with the result that the cooling device can be used in a wide range of applications with different orders of magnitude of fluid volumetric flows, without the need for structural changes. Moreover it has proven especially environmentally friendly to make the respective filter element out of materials which can be completely incinerated, so that residue-free disposal is for the most part achieved.

To improve the cooling performance, a motor-fan unit which increases the required air throughput in the finned radiator and which thus leads to improved radiator results is connected to the cooling unit, especially to its front side.

If in the region of the connecting cover on the support arm a fouling indicator is mounted, it provides information regarding the degree of fouling of the filter element which in the clogged or almost clogged state and therefore fouled state is to be replaced by a respective new one. This replacement takes place quickly and in a manner easy to install by loosening a screw connection between the filter housing and the cover part which is securely located on the support arm. In this way stationary installation of the cooling device on a hydraulic unit can also be achieved in the mobile domain, and replacement of the respective filter element can take place at some other suitable location, where overflowing fluid contamination is of no concern.

The cooling device as claimed in the invention will be detailed below using one embodiment as shown in the drawings. The figures are; schematic and not to scale.

FIG. 1 shows a perspective view of the front of the cooling device,

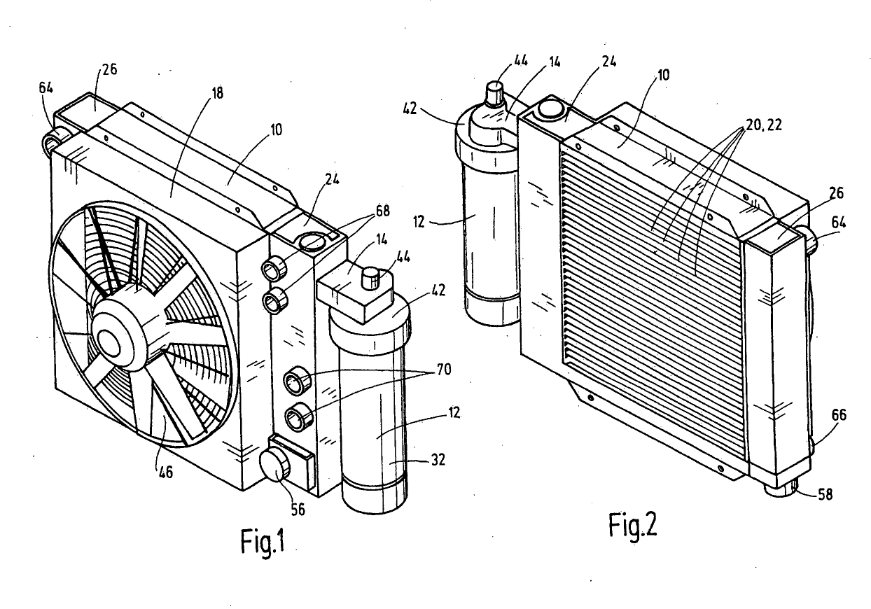

FIG. 2 shows a perspective view of the back of the cooling device,

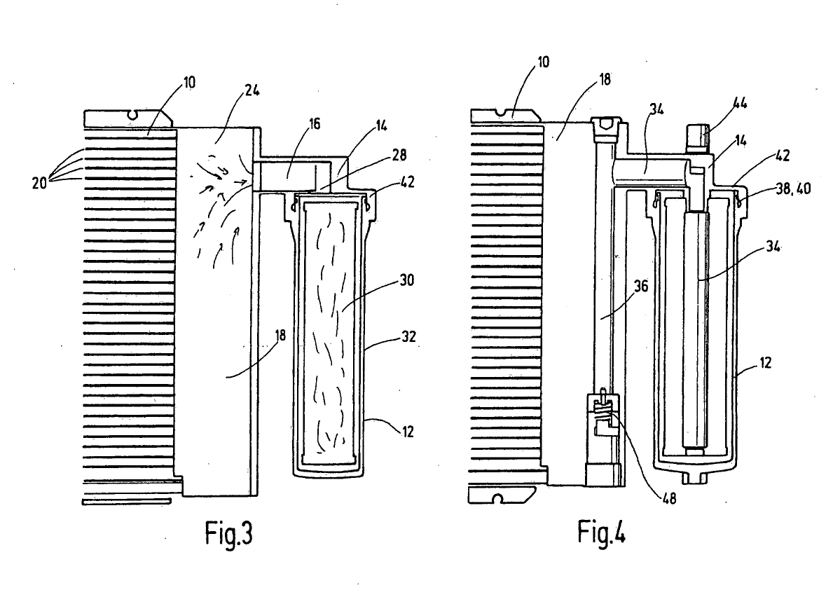

FIGS. 3 and 4 show partially in a section, partially in a front view, the fluid guidance within the filter element over the assignable support arm,

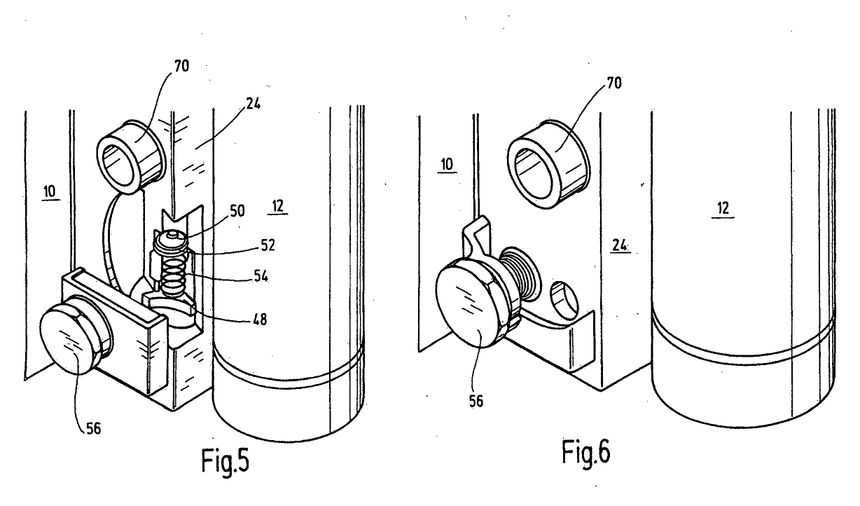

FIGS. 5, 6, and 7 show in a perspective various bypass valve solutions, to the extent they are used in the cooling device as claimed in the invention,

FIG. 8 shows the basic structure of the overall cooling device in the form of a hydraulic circuit diagram.

The cooling device has a cooling unit IO through which a fluid to be cooled, in particular hydraulic oil, can flow, and a filter unit 12 for filtration of this fluid. As FIGS. 1 to 4 show in particular, the cooling unit 10 and the filter unit 12 are integrally connected to each other via a support arm 14 with an internal fluid guide 16, the support arm 14 preferably being an integral component of the device housing 18 of the cooling unit 10. According to the embodiment shown in the drawings, the filter unit 12 is located in the flow direction of the fluid (hydraulic medium) downstream from the cooling unit 10.

Furthermore, as shown in FIG. 2, the cooling unit 10 is made as a plate-shaped, finned radiator. To guide the cooling air the plate radiator has fins 20 which are folded up in a zig-zag shape and which between themselves border fluid routing channels 22 which are used to transport the fluid to be cooled. The direction of air guidance through the cooling unit 10 runs perpendicular to the plane of FIGS. 1 and 2 and the actual fluid transport direction runs transversely thereto, that is, in the plane of the figures. Furthermore, the stacked fluid routing channels 22 discharge on either side into the fluid collecting spaces 24, 26. These collecting spaces 24, 26 form elongated fluid-carrying spaces which extend along the two longitudinal sides of the cooling unit 10. The structure of these finned radiators is in general conventional, so that it is no longer detailed here, but only to the extent necessary for explanation of the structure of the solution as claimed in the invention. The device housing 18 proper in this embodiment is composed of individual sheet metal parts; but it is also possible to produce it as an aluminum casting. If the device housing 18 is composed of sheet metal parts, it is held together via the corresponding weld connections (not shown).

The filter unit 12 on the outer peripheral side is made essentially cylindrical, and fluid supply 28 takes place in the upper edge area of the filter element 30 which is held in a pot-shaped filter housing 32 of the filter unit 12. The direction of flow of dirty fluid through the filter element 30 is from outside to inside, so that fluid removal or discharge 34 takes place by way of the interior of the filter element 30. The actual filter element 30 which can consist of conventional filtration materials and for example as a pleated hollow cylindrical filter mat surrounds a middle support tube, is received in the pot-shaped filter housing 32 from the top, and by filtering out dirt from the fluid (hydraulic medium) via the filter element 30 it is ensured that the cleaned fluid cannot form deposits in the connected hydraulic unit in such a way that operation of the entire hydraulic system is compromised.

As is to be seen in particular in FIGS. 3 and 4, viewed in the direction of looking at FIGS. 3 and 4 from left to right, cooled fluid medium flows into the shaft-like fluid collecting space 24, and collected from there flows via the internal fluid guide 16 of the support arm 14 to the filter unit 12. These inflow conditions are shown in FIG. 3. The fluid which has been cleaned by the filter element 30 is relayed via the discharge 34 and in turn via the internal fluid guide 16 of the support arm 14 into a collecting tube 36 within the collecting space 24, and in this respect fluid guidance of the supply 28 and discharge 34 located separately next to each other is achieved. As furthermore follows from these figures, the pot-like filter housing 32 on its upper end has an external thread 38 which can be fixed over the internal thread section 40 of a cover part 42 on the latter. This cover part 42 which extends from the outside over the upper area of the filter housing 32 is in turn an integral component of the support arm 14. In the middle the cover part 42 is penetrated by a fouling indicator 44 which provides information about the state of fouling of the filter element 30. These fouling indicators 44 are conventional in the field of hydraulics so that they are no longer detailed here. Furthermore, the cooling unit 10 on its one front side is provided with a motor-fan unit 46 which improves the air throughput between the free intermediate spaces of the fins 20 of the cooling unit 10.

As FIG. 5 furthermore shows, on the bottom of the collecting pipe 36 there is a combined replenishing and check valve 48 which spring-loaded as a check valve in one direction allows fluid routing to the tank, and in this way forms protection against an overpressure, and in the other direction as a replenishing valve it is possible for the fluid to be able to subsequently flow into the collecting pipe 36 coming from the tank. For this replenishment function, a head part 50 lifts off a contact plate 52 which has a fluid guide in the middle and additionally is held by the compression spring 54 in its closed position shown in FIG. 5.

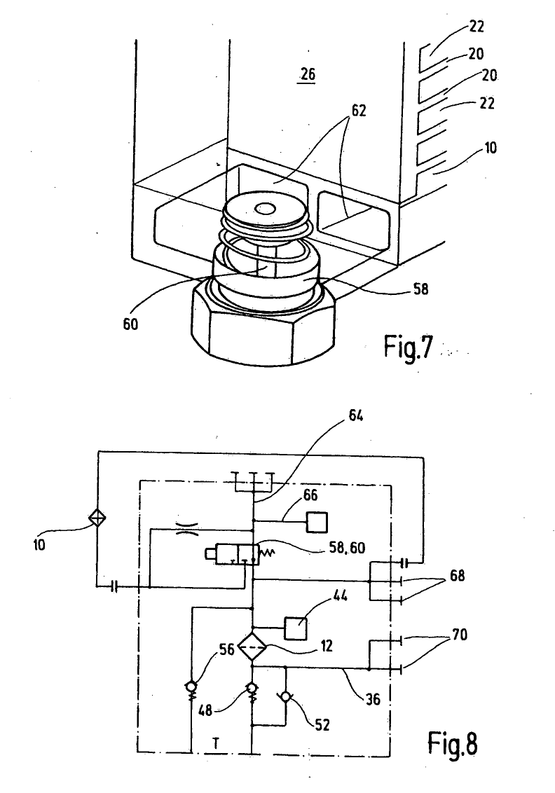

In the same region as the combined replenishing and check valve 48 there is another spring-loaded check valve 56, which, located in the fluid supply 28 in the fluid direction upstream from the filter element 30, protects the fluid cooling circuit to the tank T. As FIG. 7 furthermore shows, on the side opposite the cooling unit 10 there now is likewise on the bottom end of the fluid collecting space 26 a thermobypass valve 58 which is provided internally with an expansion element 60. These thermobypass valves 58 are conventional, so that their structure is not further detailed here. The thermobypass valve 58 is used at low fluid temperatures to directly enable fluid supply while bypassing the cooling unit 10 to the filter unit 12, specifically by way of the bypass channels 62 which run parallel to the fins 20 and are located subjacent to the latter. If at this point the fluid heats up due to operation of the hydraulic system (not shown), the expansion element 60 expands and, as heating increases, closes the bypass channels 62 so that with increasing heating of the fluid most of it is cooled by way of the fluid routing channels 22 of the cooling unit 10 and in this way is supplied to the filter unit 12 in which the medium which has been cooled in this way flows into the longitudinal shaft-shaped fluid collecting space 24.

For suitable fluid guidance the cooling unit 10 in the fluid collecting spaces 24 and 26 furthermore has the corresponding fluid connection sites, and furthermore there can be connection sites for connection of measuring units, for example for detecting the temperature of the hydraulic medium. Viewed in the direction of looking at FIG. 1, the shaft-like collecting space 26 at top left has at least one connection site for the dirty fluid which is to be cooled. Subjacent thereto (see FIG. 2) there is a connection site 66 for connection of a temperature detection unit which is not shown. On the opposite side, the longitudinal shaft 24 has two return lines 68 which are used to remove cooled fluid before running through the filter unit 12. These amounts of fluid can be used for special tasks which are not further specified for a hydraulic system. The subjacent connection sites 70 are used to connect a hydraulic suction pump which is not shown and which also ensures hydraulic circulation for the cooling unit 10 and the filter unit 12. The respective connection sites 70 as the supply of a suction pump which is not shown are located in the fluid direction downstream from the filter element 12 in the collecting space 24. The hydraulic circuit diagram illustrated in FIG. 8 clearly shows the aforementioned fluid guides and circuits, as well as the essential components of the cooling device.

1. Cooling device comprising a cooling unit (10) through which a fluid to be cooled, in particular hydraulic oil, can flow, the unit having a device housing (18) and at least one filter unit (12) for filtration of the fluid, characterized in that the device housing (18) of the cooling unit (10) has at least one overhanging support arm (14), via which the respective filter unit (12) is connected to the cooling unit (10) to carry fluid.

2. The cooling device as claimed in claim 1, wherein the overhanging support arm (14) is provided with a cover part (42) via which the filter housing (32) with at least one filter element (30) as the respective filter unit (12) can be connected to the cooling unit (10) to carry fluid.

3. The cooling device as claimed in claim 1, wherein the cooling unit (10) is made as a plate-shaped finned radiator and the filter unit (12) is located in the direction of flow of the fluid downstream from the cooling unit (10).

4. The cooling device as claimed in claim 3, wherein the filter unit (12) held by the overhanging support arm (14) extends along the longitudinal side of the finned radiator.

5. The cooling device as claimed in claim 3, wherein the cooling unit (10) is composed of sheet metal parts such that a box-shaped structure results, with two longitudinal sides, two transverse sides and one front and one rear side and wherein a fan blower (46) is integrated into the front side.

6. The cooling device as claimed in claim 4, wherein the two longitudinal sides of the cooling unit (10) are formed from two longitudinal shafts (24, 26), and wherein in one longitudinal shaft (24) at least one replenishment and check valve (45) is integrated and in the other a thermobypass valve (58).

7. A cooling device as claimed in claim 6, wherein in the respective longitudinal shaft (24, 26) there are fluid connection sites (64, 68, 70), and additionally or alternatively one connection site (66) for measurement units, especially for temperature detection.

8. The cooling device as claimed in claim 6, wherein in the longitudinal shaft (24) with the combined replenishment and check valve (48) there is another check valve (56) which opens in the direction of the tank (T).

9. The cooling device as claimed in claim 6, wherein the longitudinal shaft (24) to which the support arm (14) is connected has two fluid guides, wherein one fluid guide is used for discharge (34) of filtered fluid and the other fluid guide is used for supply (28) of unfiltered fluid coming from the cooling unit (10), and wherein one fluid guide encompasses the other or is located running laterally next to it.

10. The cooling device as claimed in claim 2, wherein the cover part (42) is provided along a retaining ring with an inside thread (40) via which the pot-like filter housing (32) with an outside thread (38) on its edge-side opening region can be screwed into the cover part (42).

11. The cooling device as claimed in claim 2, wherein the cover part (42) on its free top surface is provided with a fouling indicator (44).
